(19) United States
(12) Patent Application Publication
(10) Pub. No.: US 2024/0080718 A1
(43) Pub. Date: Mar. 7, 2024

(54) Providing Continuity to Packet-Based Services

(71) Applicant: GOOGLE LLC, Mountain View, CA (US)

(72) Inventor: Chih-Hsiang Wu, Taoyuan City (TW)

(21) Appl. No.: 18/261,668

(22) PCT Filed: Jan. 14, 2022
(86) PCT No.: PCT/US22/12617

§ 371 Date: Jul. 14, 2023

Related U.S. Application Data
(60) Provisional application No. 63/137,730, filed on Jan. 14, 2021.
(60) Provisional application No. 63/138,339, filed on Jan. 15, 2021.

(51) Int. Cl. H04W 36/00

(52) U.S. Cl. CPC H04W 36/0022; H04W 36/0016

(57) ABSTRACT

To provide Single Radio Voice Call Continuity (SRVCC) to a session of a packet-data service, a first base station communicates messages associated with the session between a UE and a packet-data network, using a first RAT (902); determines a capability of the UE with respect to the second RAT (906); and transmits, to a second base station, handover preparation information for the UE, including causing the second base station to not apply the capability of the UE with respect to UTRA (910).

### TECHNICAL FIELD

This disclosure relates generally to wireless communications and, more particularly, to managing voice and/or video services for a user equipment (UE) communication with a radio access network (RAN).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as Multi-Radio Dual Connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, i.e., single connectivity (SC). The UE in SC only communicates with the MN (via the MCG). One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station or a disaggregated base station), interconnected by a backhaul.

UEs can use several types of SRBs and DRBs. So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in single connectivity (SC) or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

In some cases, a UE can fail to complete a handover from a more advanced RAT (e.g., NR) to a less advanced RAT (e.g., EUTRA), when the UE is establishing or has already established a session of a packet-data service such as IMS voice or IMS video. In these cases, the UE may not be able to provide continuity to the packet-data service.

### SUMMARY

A base station of this disclosure can determine the capability of a UE with respect to another RAT prior to detecting conditions for initiating an inter-RAT handover. In this manner, the base station can reduce the time required for completing a handover and allows the UE to maintain continuity of a packet-data service.

Further, a UE communicating via a certain RAT in some cases reports its capability with respect to another RAT prior to receiving a query regarding the other RAT. Still further, the UE of this disclosure can process handover failures so to more quickly eliminate cells that do not qualify for the service the UE has initiated or is initiating.

An example embodiment of these techniques is a method in a first base station for providing continuity to a session of a packet-data service. The method can be executed by processing hardware and includes communicating messages associated with the session between a UE and a packet-data network, using a first RAT; prior to determining that the UE should perform a handover to a second base station that supports a second RAT, determining a capability of the UE with respect to the second RAT; and using the determined capability of the UE to perform the handover.

Another example embodiment of these techniques is a base station comprising processing hardware and configured to implement a method according to the method above.

Yet another example embodiment of these techniques is a method in a method in a user equipment (UE) for using a packet-data service. The method can be executed by processing hardware and includes communicating via a first base station using a first RAT; receiving, from the first base station, a query related to a capability of the UE with respect to only the first RAT; transmitting, to the first base station, a response to the query, the response including an indication of a capability of the UE with respect to redirection from the first RAT to a second RAT; in response to receiving a message from the first base station, connecting to a second base station using a second RAT; and communicating, via the second base station, messages associated with a session between the UE and a packet-data network.

Another example embodiment of these techniques is a UE comprising processing hardware and configured to implement a method according to the method above.

### BRIEF DESCRIPTION OF THE DRAWINGS

FIG. 1A is a block diagram of an example system in which a RAN and UE can implement the techniques for providing continuity to a session of a packet-data service;

FIG. 1B is a block diagram of an example base station including a central unit (CU) and at least one distributed unit (DU) that can operate in the system of FIG. 1A;

FIG. 2A is a block diagram of an example protocol stack according to which the UE of FIG. 1A communicates with base stations;

FIG. 2A is a block diagram of an example protocol stack according to which the UE of FIG. 1A communicates with an RNC and/or Node B;

FIG. 3 is a messaging diagram of a known scenario in which an IMS voice call established over a 5G NR interface fails when the RAN cannot provide continuity to the voice IMS call during a handover of the UE to a base station that supports the EUTRA interface;

FIG. 4A is a messaging diagram of an example scenario in which a base station determines that it should ascertain the capability of the UE with respect to another RAT, when the UE has established an IMS call via the base station, prior to determining that the UE should perform a handover to a base station that supports the other RAT;

FIG. 4B is a messaging diagram of an example scenario similar to that of FIG. 4A, but with the UE initiating but not yet establishing an IMS call via the base station, when the base station obtains the UE capability;

FIG. 5A is a messaging diagram of an example scenario in which a first base station receives a handover request from a second base station, the handover request specifying the capability of the UE with respect to another RAT and when the UE has established an IMS call via the second base station, prior to determining that the UE should perform a handover to a third base station that supports another RAT;

FIG. 5B is a messaging diagram of an example scenario similar to that of FIG. 5A, but with the UE initiating but not yet establishing an IMS call via the second base station, when the first base station receives the handover request specifying the UE capability;

FIG. 6A is a messaging diagram of an example scenario in which a first base station receives a request to resume a radio connection from a second base station, the request specifying the capability of the UE with respect to another RAT and when the UE has established an IMS call via the second base station, prior to determining that the UE should perform a handover to a third base station that supports another RAT;

FIG. 6B is a messaging diagram of an example scenario similar to that of FIG. 6A, but with the UE initiating but not yet establishing an IMS call via the second base station, when the first base station receives the request to resume the radio connection;

FIG. 7A is a flow diagram of an example method for determining the capability of a UE with respect to another RAT prior to handover initiation, which can be implemented in a base station of FIG. 1A;

FIG. 7B is a flow diagram of an example method for determining the capability of a UE with respect to another RAT in response to detecting proximity of a base station that supports the other RAT, which can be implemented in a base station of FIG. 1A;

FIG. 7C is a flow diagram of an example method for determining the capability of a UE with respect to another RAT in response to receiving a request to establish an IMS call, from the UE or the CN, which can be implemented in a base station of FIG. 1A;

FIG. 8 is a flow diagram of an example method for determining the capability of a UE with respect to another RAT and providing the capability to another base station via an interface message, which can be implemented in a base station of FIG. 1A;

FIG. 9 is a flow diagram of an example method for determining the capability of a UE with respect to another RAT and excluding certain RAT capabilities from a message to another base station via an interface message, which can be implemented a base station of FIG. 1A;

FIG. 10 is a flow diagram of an example method for determining whether a base station should provide an indication of a capability of a UE to another base station depending on the type of procedure the base stations perform, which can be implemented in a base station of FIG. 1A;

FIG. 11 is a flow diagram of an example method for determining whether a base station should query a UE to determine the capability of the UE with respect to another RAT, which can be implemented in a base station of FIG. 1A;

FIG. 12 is a flow diagram of an example method for providing RAT capability to a base station prior to redirection to another cell for establishing or continuing an IMS call, which can be implemented in a UE of FIG. 1A;

FIG. 13A is a flow diagram of an example method for determining how a base station should cause the UE to transition to another RAT for initiating or maintaining an IMS service, which can be implemented in a base station of FIG. 1A;

FIG. 13B is a flow diagram of an example method for determining whether a base station should redirect a UE to another RAT for initiating or maintaining an IMS service, which can be implemented in a base station of FIG. 1A;

FIG. 14 is a flow diagram of another example method for determining whether a base station should redirect a UE to another RAT for initiating or maintaining an IMS service, based on cell availability, which can be implemented in a base station of FIG. 1A;

FIG. 15 is a flow diagram of an example method for processing handover failure while initiating an IMS service, which can be implemented in a UE of FIG. 1A;

FIG. 16 is a flow diagram of an example method for determining whether a UE should reestablish a radio connection with a RAN after a handover failure, which can be implemented in a UE of FIG. 1A;

FIG. 17 is a flow diagram of another example method for determining whether a UE should reestablish a radio connection with a RAN after a handover failure, which can be implemented in a UE of FIG. 1A;

FIG. 18 is a flow diagram of an example method for determining whether a UE should reestablish a radio connection with a RAN after a handover failure and after the UE has initiated an IMS call, which can be implemented in a UE of FIG. 1A;

FIG. 19 is a flow diagram of an example method for determining whether a UE should reestablish a radio connection depending on whether the IMS has already been established, which can be implemented in a UE of FIG. 1A;

FIG. 20 is a flow diagram of an example method for determining whether a UE should reestablish a radio connection depending on whether the UE supports the service over a certain RAT, which can be implemented in a UE of FIG. 1A; and

FIG. 21 is a flow diagram of an example method for providing continuity to a session of a packet-data service, which can be implemented in a base station of FIG. 1A.

### DETAILED DESCRIPTION OF THE DRAWINGS

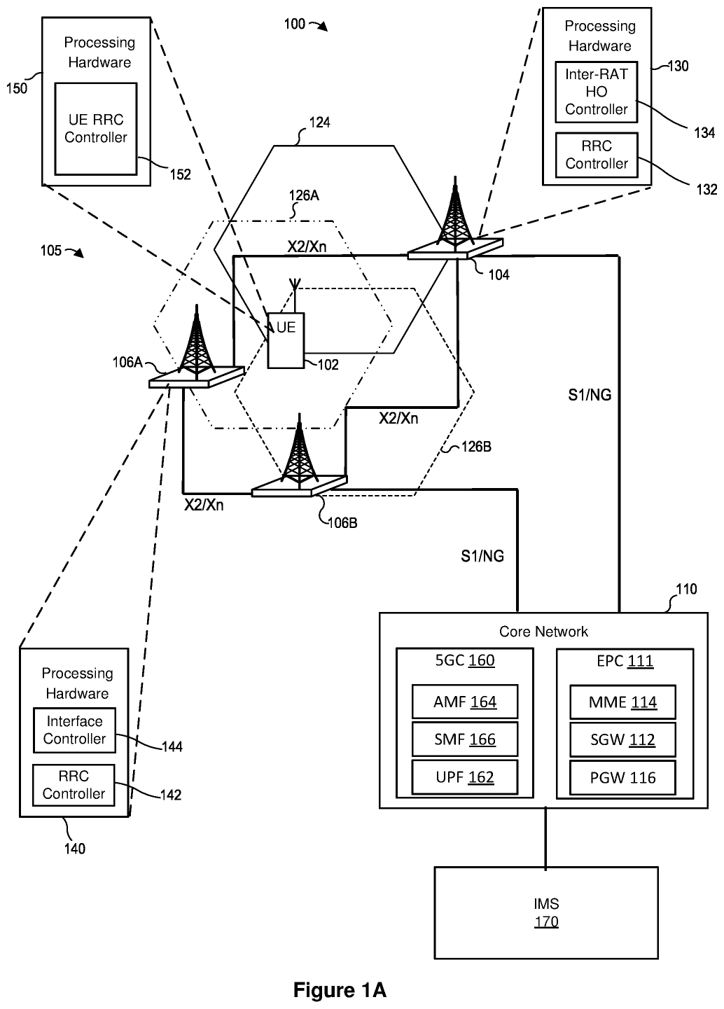

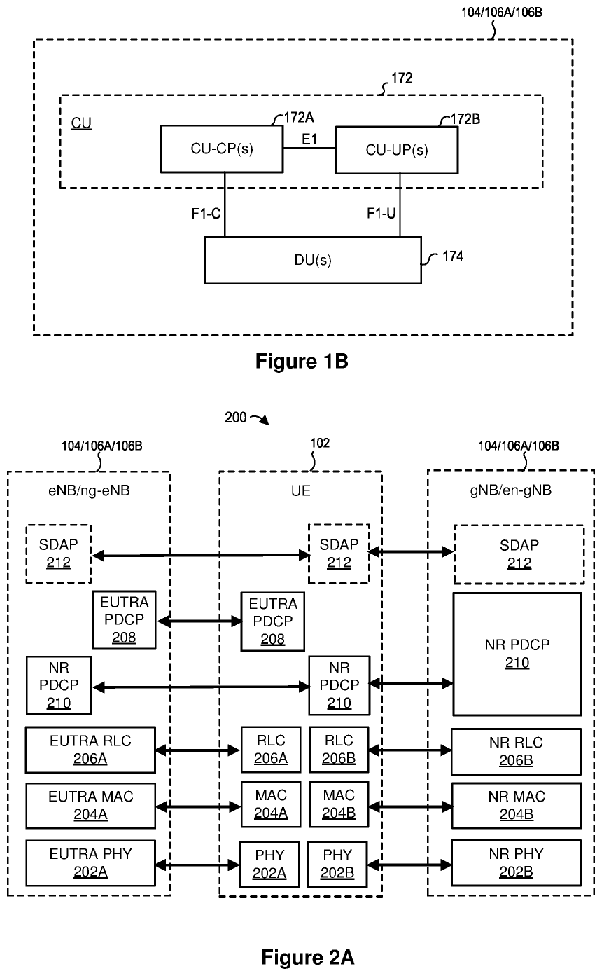

FIG. 1A depicts an example wireless communication system 100 in which communication devices can implement the techniques of this disclosure for maintaining continuity of sessions of packet-data services such as IMS voice and/or video calls.

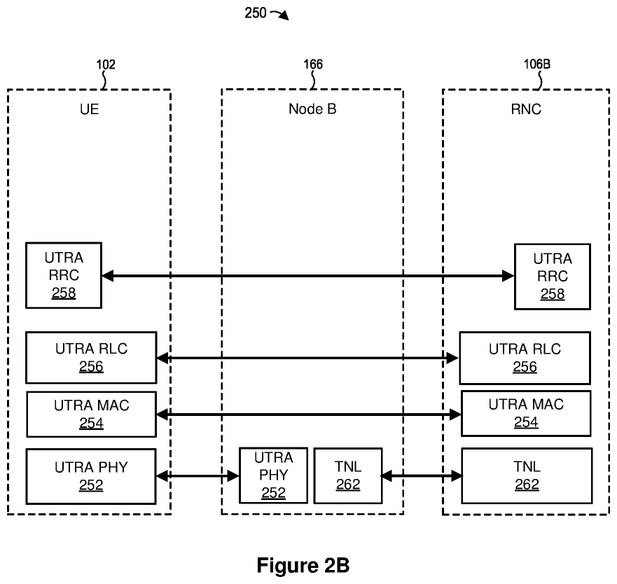

The wireless communication system 100 includes a UE 102, a base station 104, a base station 106A, a base station 106B, and a core network (CN) 110. The UE 102 initially connects to the base station 104. The base stations 104, 106A, and 106B can operate in a RAN 105 connected to the CN 110. The CN 110 can be implemented as an evolved packet core (EPC) 111 or a fifth generation (5G) core (5GC), 160, for example. Depending on the implementation and/or scenario, the CN 110 can include a third generation (3G) core network (i.e., a UMTS core network) and the base station 106B supports a UMTS Terrestrial Radio Access (UTRA) and is connected to the 3G core network. In such implementation and/or scenario, the UMTS core network includes a Mobile Switching Center (MSC), and the base station 106B can be a radio network controller (RNC) connecting to a Node B shown in FIG. 2B.

Among other components, the EPC 111 can include a Serving Gateway (SGW) 112, a Mobility Management Entity (MME) 114, and a Packet Data Network Gateway (PGW) 116. Generally speaking, the SGW 112 is configured to transfer user-plane packets related to audio calls, video calls, Internet traffic, etc., and the MME 114 is configured to manage authentication, registration, paging, and other related functions. The PGW 116 provides connectivity from the UE to external packet data networks including Internet network and/or an Internet Protocol (IP) Multimedia Subsystem (IMS) network by being the point of exit and entry of traffic for the UE. The 5GC 160 includes a User Plane Function (UPF) 162, an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions. In some implementations, the CN 110 can also include a UMTS core network not shown in FIG. 1A. The UMTS core network can include a mobile switching center (MSC), a Serving GPRS Support Node (SGSN), and/or a Gateway GPRS Support Node (GGSN).

As illustrated in FIG. 1A, the base station 104 supports a cell 124, the base station 106A supports a cell 126A, and the base station 106B supports a cell 126B. The base station 104 can additionally support a cell 122, and the base station 106A can additionally support a cell 128A. The cells 124 and 126A can partially overlap, so that the UE 102 can communicate in DC with the base station 104 and the base station 106A operating as a master node (MN) and a secondary node (SN), respectively. To directly exchange messages during DC scenarios and other scenarios discussed below, the MN 104 and the SN 106A can support an X2 or Xn interface. In general, the CN 110 can connect to any suitable number of base stations supporting NR cells and/or EUTRA cells. In some cases, the base station 106B can be a UTRA base station connecting to the 3G core network in the CN 110.

With continued reference to FIG. 1A, the base station 104 is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes an RRC controller 132 configured to manage RRC procedures such as RRC connection reestablishment procedure, RRC reconfiguration procedure, handover procedure, reconfiguration with sync procedure, and/or measurement configuration and reporting procedure, discussed with reference to the message and flow diagrams below. The processing hardware 130 also includes an inter-RAT HO controller 134 configured to manage network procedures with the CN 110 and/or another base station (e.g., the base station 106A, 106B), discussed with reference to the message and flow diagrams below.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes an RRC controller 142 configured to manage RRC procedures such as RRC connection reestablishment procedure, RRC reconfiguration procedure, handover procedure, reconfiguration with sync procedure, and/or measurement configuration and reporting procedure, discussed with reference to the message and flow diagrams below. The processing hardware 140 also includes an interface controller 144 configured to manage network procedures with the CN 110 and/or another base station (e.g., the base station 106A, 106B), discussed with reference to the message and flow diagrams below. The base station 106B can have hardware that is the same as or similar to the base station 104 or the base station 106A.

Alternatively, the base station 106B supports LTE (i.e., EUTRA) and has hardware that is different from the base stations 104 and 106A supporting NR. In such alternative, processing hardware of the base station 106B includes an EUTRA RRC controller configured to manage EUTRA RRC procedures such as RRC connection reestablishment procedure, RRC connection reconfiguration procedure, handover procedure, and/or measurement configuration and reporting procedure, discussed with reference to the message and flow diagrams below. The processing hardware also includes an interface controller configured to manage network procedures with the EPC 111, discussed with reference to the message and flow diagrams below.

Alternatively, the base station 106B supports UTRA and has hardware that is different from the base station 104 or 106A supporting NR or EUTRA. In such alternative, processing hardware of the base station 106B includes an UTRA RRC controller configured to manage UTRA RRC procedures such as cell update procedure, radio bearer reconfiguration procedure, transport channel reconfiguration procedure, physical channel reconfiguration procedure, handover to UTRAN procedure, and/or measurement configuration and reporting procedure, discussed with reference to the message and flow diagrams below. The processing hardware also includes an interface controller configured to manage network procedures with a UMTS core network, discussed with reference to the message and flow diagrams below.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC controller 152 configured to manage RRC procedures such as RRC connection reestablishment procedure, RRC reconfiguration procedure, handover procedure, reconfiguration with sync procedure, and/or measurement configuration and reporting procedure, discussed with reference to the message and flow diagrams below. In some implementations, the processing hardware 150 additionally includes a UTRA RRC controller configured to manage UTRA RRC procedures such as RRC connection reestablishment procedure, radio bearer reconfiguration procedure, transport channel reconfiguration procedure, physical channel reconfiguration procedure, handover procedure, and/or measurement configuration and reporting procedure, discussed with reference to the message and flow diagrams below, discussed with reference to the message and flow diagrams below.

In operation, the UE 102 can use one or more radio bearer (e.g., DRB(s) and/or an SRB(s)) to communicate with the base station 104. The UE 102 can receive a radio bearer configuration configuring the radio bearer from the base station 104. The UE 102 can apply one or more security keys when communicating on the radio bearer, in the uplink (from the UE 102 to a base station) and/or downlink (from a base station to the UE 102) direction. The UE 102 in some cases can use different RATs to communicate with the base stations 104 and 106A. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core networks.

With continued reference to FIG. 1A, the CN 110 communicatively connects the UE 102, to an Internet Protocol (IP) Multimedia Subsystem (IMS) network 170, via the RAN 105. The IMS network 170 can provide to the UE 102 various IMS services, such as IMS short messages, IMS unstructured supplementary service data (USSD), IMS value added service data, IMS supplementary service data, IMS voice calls, and IMS video calls. To this end, an entity (e.g., a server or a group of servers) operating in the IMS network 170 supports packet exchange with the UE. The packets can convey signaling (such as session initiation protocol (SIP) messages, IP messages, or other suitable messages) as well as data (“or media”) such as voice or video. Although the techniques of this disclosure are discussed with specific reference to IMS, the CN 110 in general can connect to, or include, any suitable system that provides packet-based calls.

FIG. 1B depicts an example distributed implementation of any one or more of the base stations 104, 106A, 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2A illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to a NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to an Ethernet protocol layer (not shown in FIG. 2A), an Internet Protocol (IP) layer (not shown in FIG. 2A), Service Data Adaptation Protocol (SDAP) 212 and/or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 according to which the UE 102 can communicate with an RNC and/or Node B (e.g., the base stations 106B).

In the example stack 250, a physical layer (PHY) 252 of UTRA provides transport channels to the UTRA MAC sublayer 254, which in turn provides logical channels to the UTRA RLC sublayer 256. The UTRA RLC sublayer 256 in turn provides RLC channels to an UTRA PDCP sublayer (not shown in FIG. 2B), and/or a radio resource control (RRC) sublayer 258. The PDCP sublayer in turn can provide data transfer services to an IP layer (not shown in FIG. 2B). In some implementations, the UTRA RLC sublayer 256 can provide data transfer services to voice and/or video codec(s), which generates voice and/or video packets for transmission and processes received voice and/or video packets. In other implementations, the UTRA MAC sublayer 254 can provide data transfer services to voice and/or video codec(s), which generates voice and/or packets for transmission and processes received voice packets instead of the UTRA RLC sublayer 256. The UE 102, in some implementations, supports both the NR stack as shown in FIG. 2A and UTRA stack as shown in FIG. 2B, to support handover from a NR base station to a UTRA base station for a voice or video call.

On a control plane, the UTRA RLC sublayer 256 can provide SRBs to exchange RRC messages or non-access-stratum (NAS) messages, for example. On a user plane, the UTRA RLC sublayer 256 and/or the UTRA PDCP sublayer can provide DRBs to support data exchange. Data exchanged on the PDCP sublayer can be Internet Protocol (IP) packets.

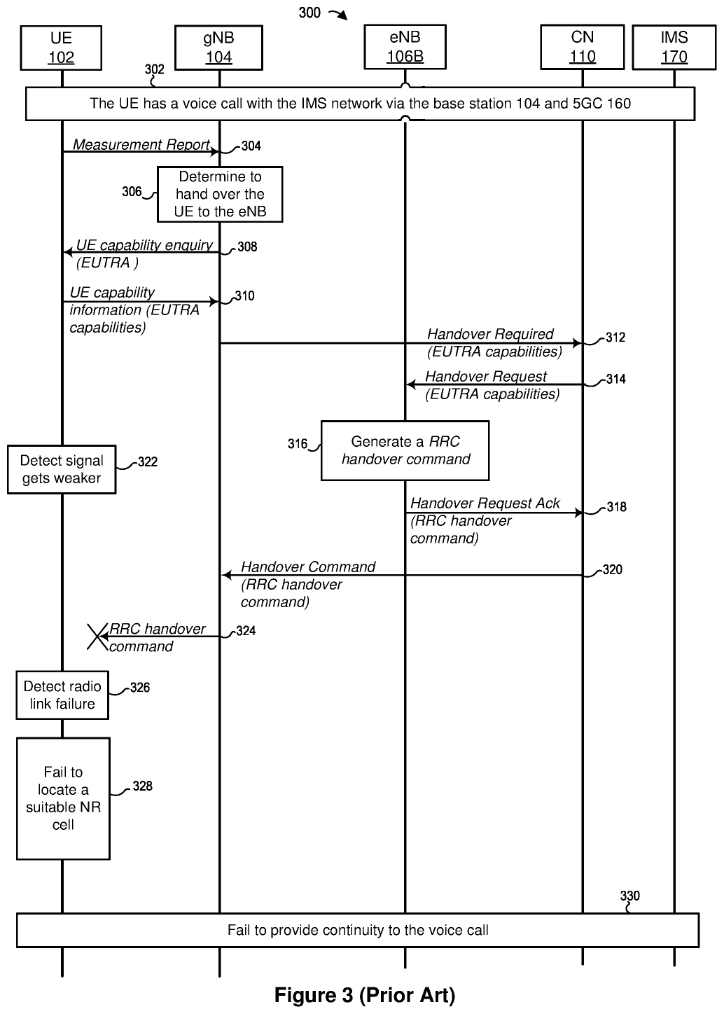

Next, FIG. 3 illustrates a known scenario in which an IMS voice call established over a 5G NR interface fails when the RAN cannot provide continuity to the voice IMS call, during a handover of the UE to a base station that supports the EUTRA interface. The base station 104 in scenario 300 operates as a gNB, and the base station 106B operates as an eNB. Initially, the UE 102 operates 302 in an IMS voice call with an IMS network 170 via the gNB 104 (e.g., on cell 124) and CN 110 (e.g., 5GC 160). The UE 102 later transmits 304 a Measurement Report message to the gNB 104. In accordance with measurement result(s) in the Measurement Report message, the gNB 104 determines 306 to hand over the UE 102 to the eNB 106B. In response to the determination 306, the gNB 104 transmits 308 a UE capability enquiry message (e.g., UECapabilityEnquiry message) including a “EUTRA” indication to the UE 102 to obtain LTE (e.g., EUTRA) capabilities from the UE 102. In response to the “EUTRA” indication, the UE 102 transmits 310 a UE capability information message (e.g., UECapabilityInformation message) including EUTRA capabilities to the gNB 104.

In some implementations, the UE 102 generates an UE-EUTRA-Capability IE including the EUTRA capabilities, includes the UE-EUTRA-Capability IE in the UE capability information message and transmits 310 the UE capability information message to the gNB 104. After receiving the UE capability information message, the gNB 104 transmits 312 a Handover Required message including the EUTRA capabilities (e.g., UE-EUTRA-Capability IE) to the CN 110. After receiving the Handover Required message, the CN 110 transmits 314 a Handover Request message including the EUTRA capabilities to the eNB 106B. In some implementations, the gNB 104 transmits 312 the Handover Required message to the 5GC 160 (e.g., AMF 164), which in turn send a (Forward) Relocation Request message including the EUTRA capabilities (e.g., UE-EUTRA-Capability IE) to the EPC 111. In response to or after receiving the (Forward) Relocation Request message, the CN 110 transmits 314 the Handover Request message to the eNB 106B.

In response to the Handover Request message, the eNB 106B generates 316 an RRC handover command message (e.g., RRCConnectionReconfiguration message as specified in 3GPP specification 36.331). In some implementations, the eNB 106B generates configuration parameters in accordance with the EUTRA capabilities and include the configuration parameters in the RRC handover command message. In other implementations, the eNB 106A generates configuration parameters in accordance with default UE capabilities, i.e., not referring to the UE capabilities.

After generating 316 the RRC handover command message, the RNC 106B transmits 318 a Handover Request Acknowledge message including the RRC handover command message to the CN 110. After receiving 318 the Handover Request Acknowledge message, the CN 110 transmits 320 a Handover Command message including the RRC handover command message to the gNB 104. In some implementations, the EPC 111 receives 318 the Handover Request Acknowledge message and in turn transmits a (Forward) Relocation Response message including the RRC handover command message to the CN 110. The CN 110 then transmits 320 the Handover Command message to the gNB 104, which in turn transmits 324 the RRC handover command message to the UE 102 via cell 124. In some implementations, the gNB 104 transmits 324 a MobilityFromNRCommand message including the RRC handover command message to the UE 102.

However, the process of preparing the handover from the gNB 104 to the eNB 106B can take a significant amount of time. During this time, the UE 102 can determine 322 that the signal from the gNB 104 becomes weak. The UE 102 as a result does not receive 325 the Handover to UTRAN Command message and eventually detects 326 a radio link failure on the radio connection with the gNB 104 via cell 124. In particular, it can take 80 ms for the UE 102 to generate and transmit 310 the UE capability information message, according to 3GPP specification 38.331. The 80 ms introduces a significant delay during handover preparation. After detecting 326 the radio link failure, the UE 102 may perform an RRC connection reestablishment procedure to recover the radio link failure. The UE 102 can search 328 all NR carrier frequencies that the UE 102 supports to find a suitable NR cell to perform the RRC connection reestablishment procedure. However, the UE 102 in some cases cannot find a suitable NR cell to perform the RRC connection reestablishment procedure because the UE 102 has left NR coverage. Consequently, the UE 102 fails to recover the radio link failure, which leads to that the voice call dropping 330.

Similar problems may occur in case of a handover from the gNB 104 to an 3G base station (e.g., RNC). In this case, even though the UE 102 can find a suitable NR cell to perform the RRC connection reestablishment procedure, the IMS network 170 may not be able to continue the voice call because the voice call may have been converted to a circuit-switched (CS) type from an IMS type during the handover preparation.

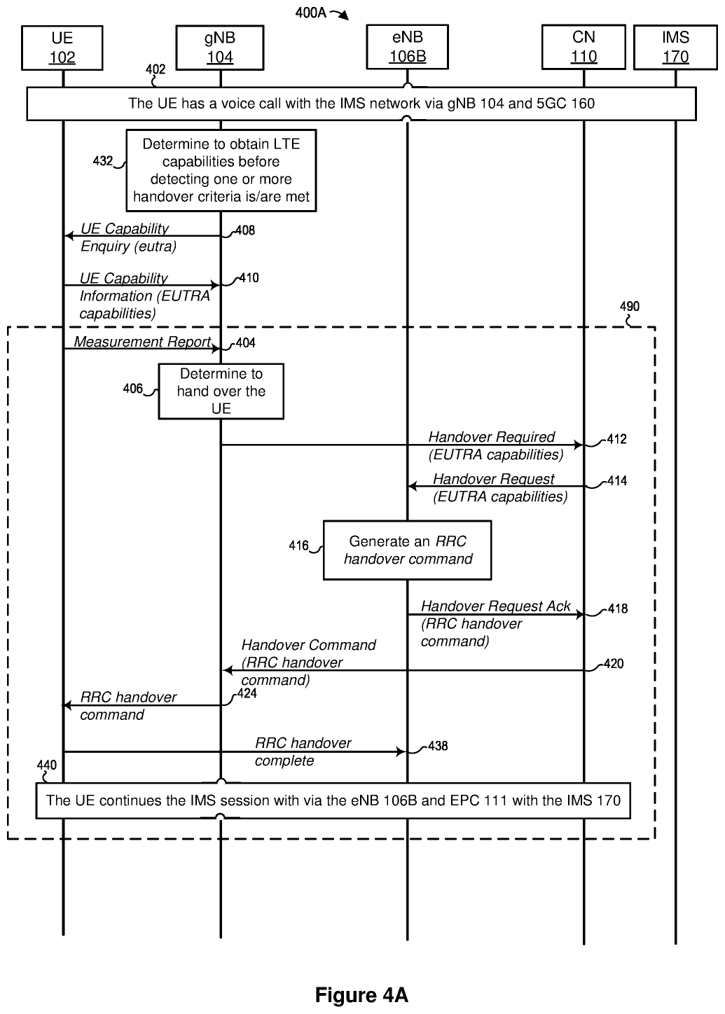

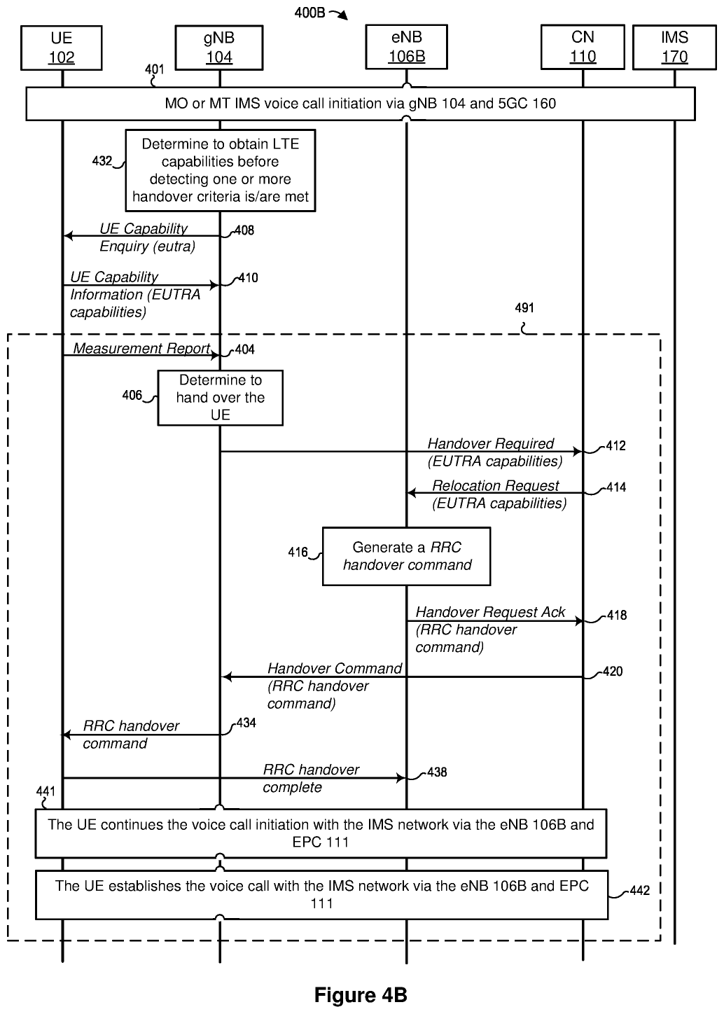

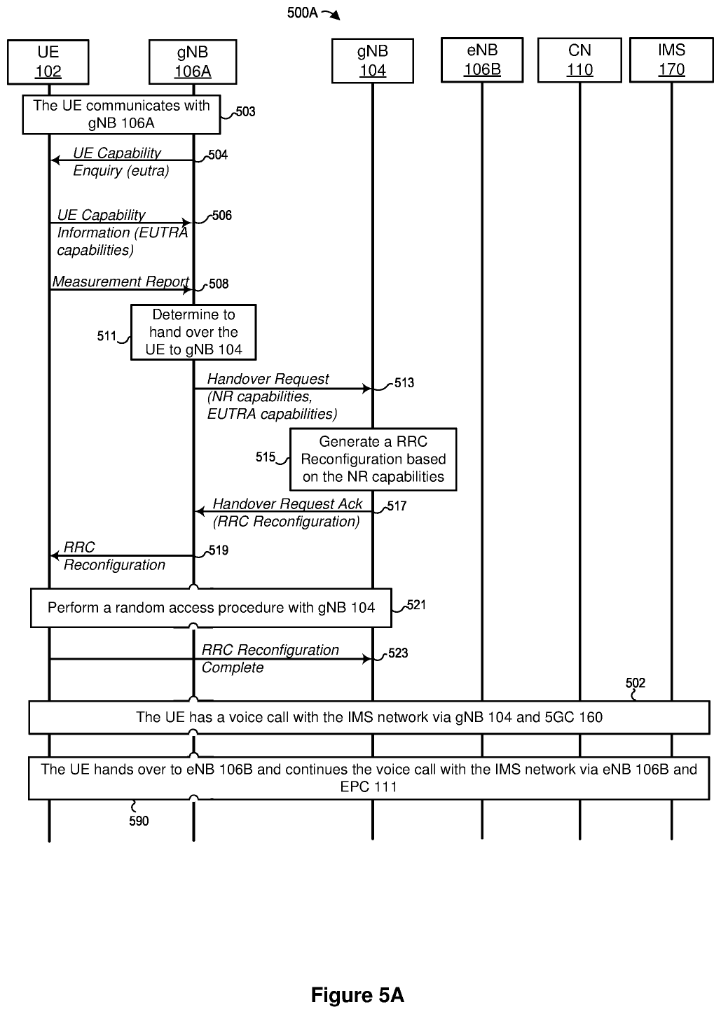

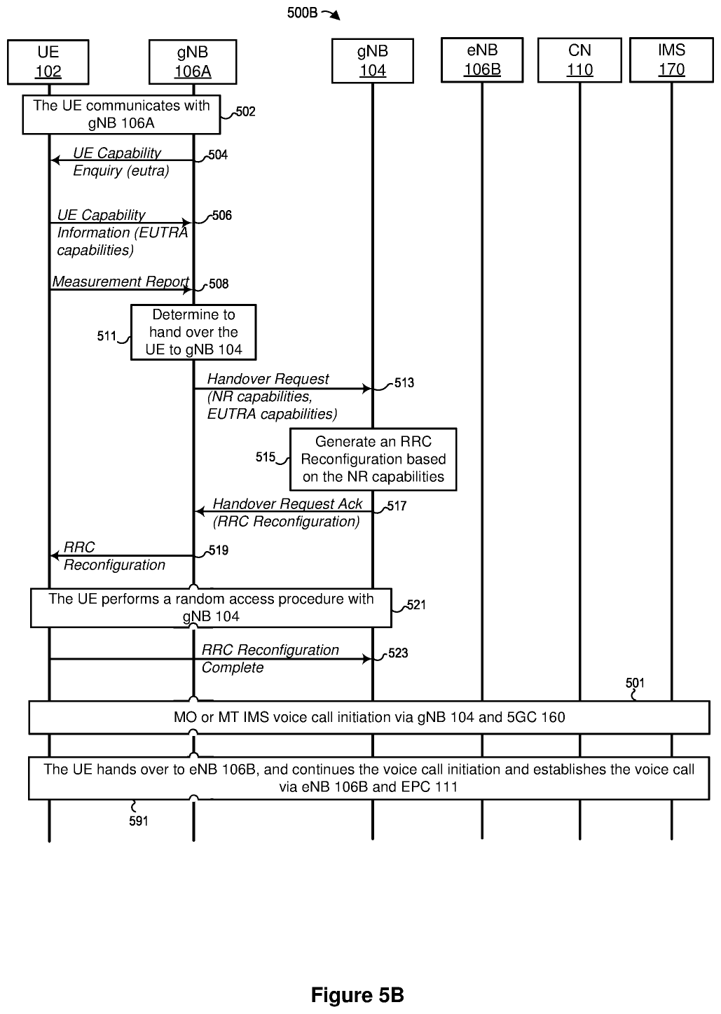

Next, FIGS. 4A-6B illustrate several scenarios in which the RAN 105 ascertains the UE capability with respect to EUTRA more efficiently, which allows the UE 102 to maintain the IMS service. Similar techniques can be implemented in a RAN with base stations that support NR and UTRA interfaces, EUTRA and UTRA interfaces, etc. Generally speaking, events in FIGS. 4A-5B that may be similar are labeled with similar reference numbers (e.g., event 402 may be similar to event 502, 602, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 4A, an example scenario 400 begins with the UE 102 operates 402 in an IMS voice call with an IMS network 170 via the gNB 104. In other, similar scenarios, the IMS call can be a video call. More generally, the procedure 402 can involve a session of any suitable packet-data service.

For simplicity, in the discussion below, the 5GC 160 and the EPC 111 can be referred to as the CN 110. It will be understood that, depending on the scenario, messages related to handover, IMS services, etc. can travel between the RAN 105 and the 5GC 160, and in other cases between the RAN 105 and the EPC 111.

At some point after the UE 102 has started exchanging data packets with the IMS 170, the gNB 104 determines that it should ascertain the capability of the UE with respect to LTE. The gNB 104 at this point has not determined that a handover to a suitable cell will be necessary. In some implementations or scenarios, the gNB 104 makes the determination 432 unconditionally. In other implementations or scenarios, the gNB 104 determines that the cell in which the UE 102 operates overlaps, or is entirely covered by, a cell of the eNB 106B. In yet other implementations or scenarios, the gNB 104 determines that although the signal strength and/or quality measurements for the UE 102 do not yet trigger handover preparation, the signal strength and/or quality measurements evolve in the direction that suggests that a handover may occur in the near future (e.g., within a certain predetermined period of time). The gNB 104 in still other cases can determine 432 that some, but not all, of multiple conditions for a handover are satisfied.

In response to the determination 432, the gNB 104 queries 408 the UE 102 via the 5G NR interface and receives 410 a response, similar to events 308 and 310 discussed above. The response of event 410 specifies EUTRA capabilities such as whether the UE 102 supports IMS voice over EUTRA, IMS video over EUTRA, EPS fallback, etc. The gNB 104 can use the determined UE capability with respect to EUTRA to subsequently maintain continuity of the session of the procedure 402. In some cases, however, the gNB 104 does not utilize the determined EUTRA capability.

In some implementations, the gNB 104 can make the determination 432 and obtains the EUTRA capabilities from the UE 102 in the UE capability information procedure at events 408 and 410, before the UE 102 has a voice call (initiation) with the IMS network.

In particular, the gNB 104 can receive 404 a measurement report from the UE 102 and, based on the measurement report, determine 406 that the gNB 104 should initiate a handover of the UE 102 to a cell of the eNB 106B. Similar to events 312 and 314 discussed above, the gNB 104 can send 412 a Handover Required message including the EUTRA capabilities (e.g., UE-EUTRA-Capability IE) to the CN 110, and the CN 110 transmits 414 a Handover Request message including the EUTRA capabilities to the eNB 106B. However, unlike the scenario of FIG. 3 discussed above, here the gNB 104 already has the EUTRA information for the UE 102 immediately available for reporting to the CN 110 upon the determination 406.

The eNB 106B and the UE 102 in this example scenario support the corresponding IMS service (e.g., voice) over the EUTRA interface. In response to receiving 414 the Handover Request message, the eNB 106B generates 416 an RRC handover command message, similar to event 316 discussed above. After generating 316 the RRC handover command message, the eNB 106B transmits 318 a Handover Request Acknowledge message including the RRC handover command message to the CN 110. After receiving 418 the Handover Request Acknowledge message, the CN 110 transmits 420 a Handover Command message including the RRC handover command message to the gNB 104. The CN 110 transmits 420 the Handover Command message to the gNB 104, which in turn transmits 424 the RRC handover command message to the UE 102 in the cell 124. In some implementations, the gNB 104 transmits 424 a MobilityFromNRCommand message including the RRC handover command message to the UE 102.

The UE 102 then can continue the IMS session with the IMS 170, but via the eNB 106B and the EPC 111 and the EPC 111 rather than gNB 104 and the 5GC 160 of the procedure 402. Collectively, events 404-440 can be referred to as an inter-RAT IMS session handover procedure 490.

Next, FIG. 4B illustrates a messaging diagram of an example scenario 400B generally similar to that of FIG. 4A, but with the UE only initiating 401 an IMS call via the gNB 104 and the 5GC 160, rather than having established a session as in the event 402. Accordingly, rather than participating in the inter-RAT IMS session handover procedure 490, the gNB 104 here participates in an inter-RAT IMS session initiation handover procedure 491. The procedure 491 is similar to the procedure 490, but includes a voice call initiation procedure 441 and a voice call establishment procedure 442 instead of the procedure 440.

Now referring to FIG. 5A, an example scenario 500A begins with the UE 102 communicating 503 with a gNB 106A. The gNB 106A determines 504, 506 the EUTRA capability of the UE 102 prior to handing the UE 102 over to another base station that operates using the same RAT, the gNB 104, in response to receiving 508 a measurement report. After the gNB 106A determines 511 to hand the UE 102 over to the gNB 104, the gNB 106A transmits 513 a Handover Request message to the eNB 104. The gNB 106A includes both NR and EUTRA capabilities in the Handover Request message.

The gNB 104 generates 515 an RRC reconfiguration for the UE 102 based on the received NR capabilities and transmits 517 a Handover Request Acknowledge message including the RRC reconfiguration to the gNB 106A, and the gNB 106A accordingly provides 519 the RRC reconfiguration to the UE 102. The UE 102 then performs 521 a random access procedure with the gNB 104 and eventually transmits 523 an RRC Reconfiguration Complete message to the gNB 104.

Thus, the gNB 104 at this point already has determined the capability of the UE 102 with respect to EUTRA. As illustrated in FIG. 5A, the UE 102 then operates 502 in an IMS voice call with an IMS network 170 via the gNB 104. The UE 102 then performs an inter-RAT IMS session handover procedure 590 similar to the procedure 490. The procedure 590 is efficient (similar to the procedure 490) because the gNB 104 does not need to query the UE 102 with respect to its EUTRA capability.

Referring now to FIG. 5B, the scenario 500B is similar to the scenario 500A, except that the gNB 104 performs procedures 501 and 591 similar to the procedures 401 and 490, respectively, to transfer an initiation of a session of an IMS call rather than an already-established session.

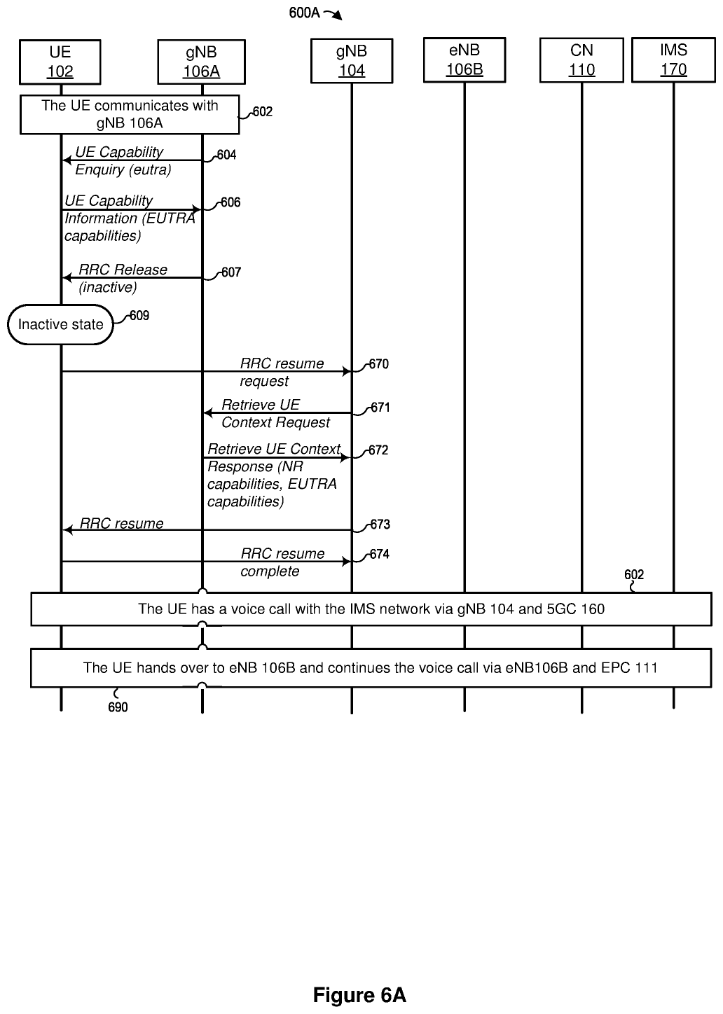

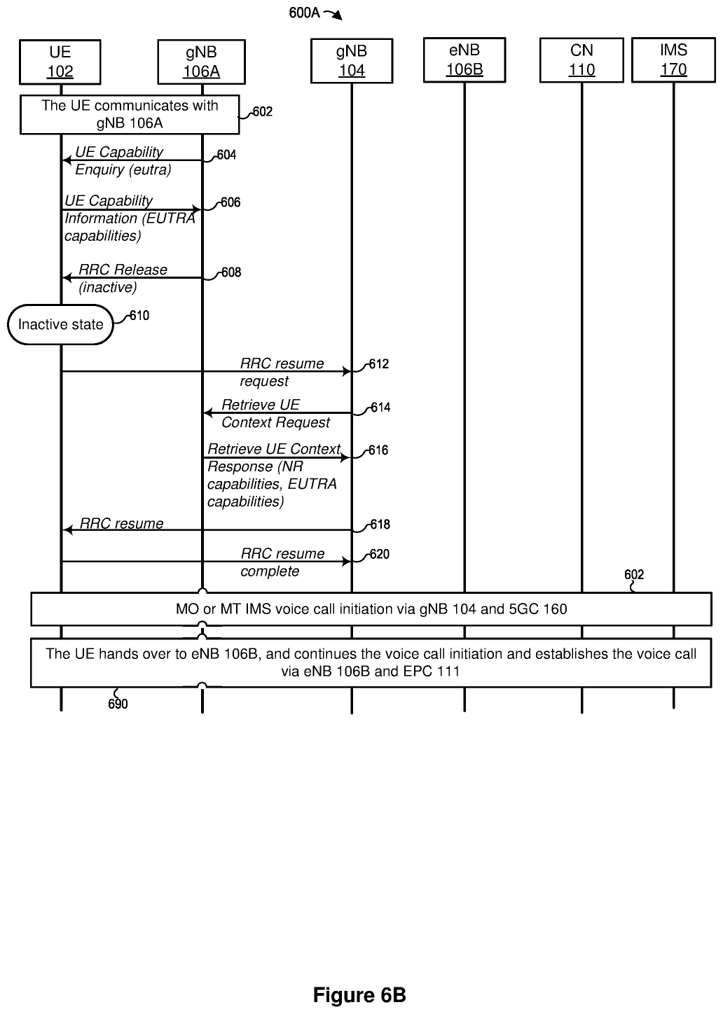

FIG. 6A is a messaging diagram of an example scenario 600A in which the UE 102 initially also communicates with the gNB 106A, similar to the scenario of FIG. 5A. Here, however, the gNB 106A instructs the UE to transition to the RRC_INACTIVE state by transmitting 607 an RRC Release command with an inactive indication. After operating 609 in the RRC_INACTIVE state, the UE transmits 670 an RRC Resume Request message to the gNB 104. For example, the UE 102 may have changed its location and detects better signal measurements in an NR cell of the gNB 104.

The gNB 104 then transmits 671 a Retrieve UE Context Request message to the gNB 106A and receives 672 a Retrieve UE Context Response message from the gNB 106A in response. The Retrieve UE Context Response message can include both NR and EUTRA capabilities. The gNB 104 then transmits 673 an RRC Resume command to the UE 102, and the UE 102 responds 674 with RRC Resume Complete. The UE 102 also transitions back to the RRC_CONNECTED state.

Thus, similar to the scenarios discussed above, the gNB 104 at this point already has determined the capability of the UE 102 with respect to EUTRA. The UE 102 then operates 602 in an IMS voice call with an IMS network 170 via the gNB 104. The UE 102 then performs an inter-RAT IMS session handover procedure 690 similar to the procedure 490. The procedure 690 is efficient (similar to the procedure 490) because the gNB 104 does not need to query the UE 102 with respect to its EUTRA capability.

Referring now to FIG. 6B, the scenario 600B is similar to the scenario 600A, except that the gNB 104 performs procedures 601 and 691 similar to the procedures 401 and 490, respectively, to transfer an initiation of a session of an IMS call rather than an already-established session.

Referring generally to the scenarios above, the source base station (e.g., gNB 106A) in some cases can determine that it should not forward the UTRA capabilities to the target NG-RAN (e.g., the gNB 104), in order to properly support Single Radio Voice Call Continuity (SRVCC) from NR to UTRAN.

In particular, UTRAN capabilities as described in TS 36.300 and 38.30 (INTER RAT HANDOVER INFO) include START-CS, START-PS, and “predefined configurations”, which are “dynamic” IEs. In order to avoid the START values desynchronisation and the key replaying issue, a source gNB (e.g., the gNB 106A) or an eNB always requests the UE UTRA-FDD capabilities before handover to UTRA-FDD. If the source RAN (e.g., the gNB 106A) forwards UTRA capabilities to the target NG-RAN (e.g., the gNB 104), the START value desynchronization may occur in SRVCC handover from target NG-RAN to UTRAN.

For this reason, the source base station of this disclosure does not forward the UE capabilities to the target NG-RAN. The base station for example can omit (not include) UTRA capabilities from HandoverPreparationlnformation. The base station can use the HandoverPreparationlnformation message to transfer the NR RRC information used by the target gNB during handover preparation or UE context retrieval, e.g. in case of resume or re-establishment, including UE capability information. This message also can be used for transferring the information between the CU and DU.

As a more specific example, the HandoverPreparationlnformation message can include HandoverPreparationlnformation-IEs with a ue-CapabilityRAT-List field of type UE-CapabilityRAT-ContainerList. When the source RAT is NR, the base station (e.g., the gNB 106A) can choose to not include UTRA capabilities. When the source RAT is EUTRAN, the base station (e.g., the eNB 106B) also can choose to not include UTRA capabilities.

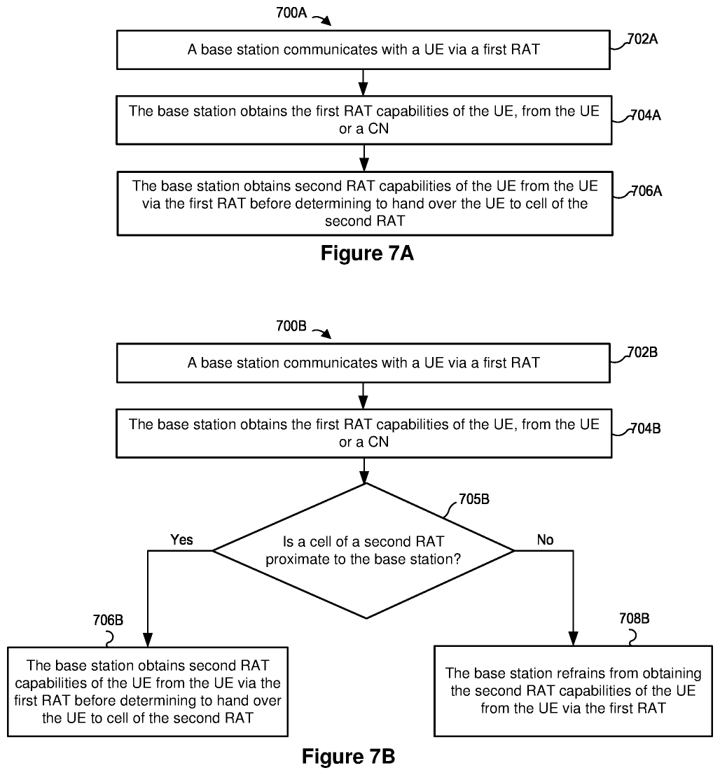

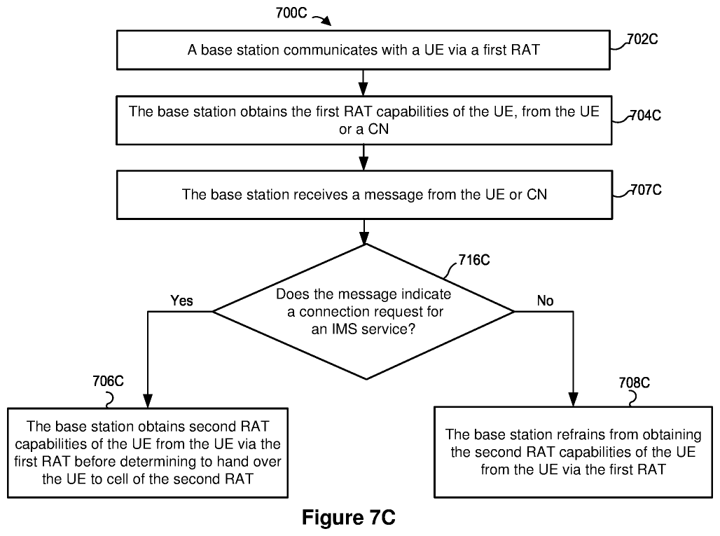

Next, several scenarios that can be implemented in a base station or a UE of FIG. 1A are discussed next. Generally speaking, events in FIGS. 7A-21 that may be similar are labeled with similar reference numbers (e.g., event 702 may be similar to event 802, 902, etc.), with differences discussed below where appropriate.

Referring first to FIG. 7A, an example method 700A for determining the capability of a UE with respect to another RAT prior to handover initiation can be implemented in the base station gNB 104, for example. At block 702A, the base station communicates with a UE via a first RAT. At block 704A, the base station obtains the first RAT capabilities (e.g., NR) of the UE. To this end, the base station can query the UE or obtain the first RAT capabilities from the CN. At block 706A, the base station obtains second RAT capabilities (e.g., EUTRA) of the UE, via the first RAT. The base station does so prior to determining that the UE should perform a handover to another base station that operates using the second RAT.

Now referring to FIG. 7B, an example method 700B for determining the capability of a UE with respect to another RAT prior to handover initiation also can be implemented in the base station gNB 104, for example. Blocks 702B and 704B are similar to blocks 702A and 704A, respectively. At block 705B, the base station determines whether the cell in which the UE 102 can operate using the second RAT is proximate to the base station executing the method 700B. As discussed above, an NR cell of the gNB 104 can overlap or be within the EUTRA cell of the eNB 106B. When the decision at block 705B is “yes,” the flow proceeds to block 706B, which is similar to block 706A of FIG. 7A. Otherwise, the flow proceeds to block 708B, where the base station refrains from obtaining the second RAT capabilities of the UE.

Now referring to FIG. 7C, an example method 700C for determining the capability of a UE with respect to another RAT prior to handover initiation also can be implemented in the base station gNB 104, for example. Blocks 702C and 704BCare similar to blocks 702A and 704A, respectively. At block 707, the base station receives a message from the UE or the CN. If the message indicates a connection request for an IMS service (block 716C), the flow proceeds to block 706C; otherwise, the flow proceeds to block 708C. Blocks 706C and 708C are similar to blocks 706B and 708B, respectively.

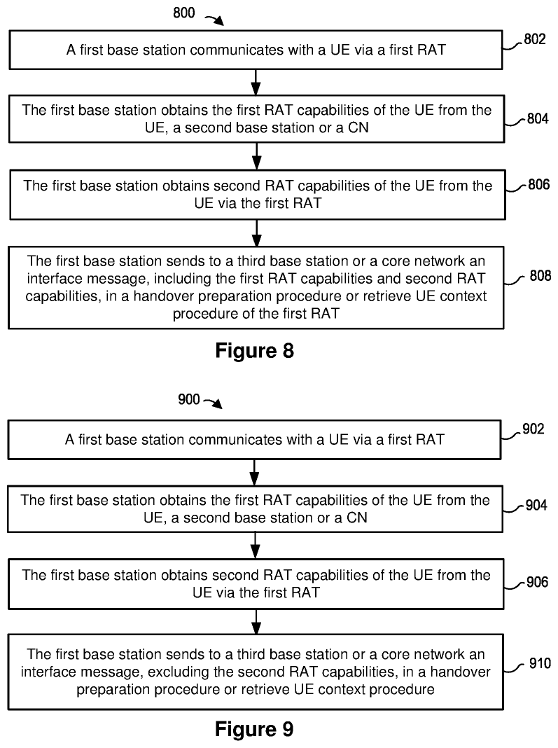

Next, FIG. 8 illustrates an example method 800 for determining the capability of a UE with respect to another RAT and providing the capability to another base station via an interface message, which can be implemented in gNB 104, for example. At block 802, the base station communicates with a UE via a first RAT. At block 804, the base station obtains the first RAT capabilities (e.g., NR) of the UE. At block 806, the base station obtains second RAT capabilities (e.g., EUTRA) of the UE, via the first RAT. Then, at block 80, the base station transmits the determined first RAT and second RAT capabilities to a third base station or a core network. The base station can do so during a handover preparation procedure or during a procedure for retrieving a UE context.

On the other hand, according to a method 900 of FIG. 9, the base station determines the first and second RAT capabilities at blocks 902-906 similar to the method of FIG. 8, but here the base station excludes the UE capabilities for the other RATs, and at block 910 reports only the capability directly related to the procedure being directly performed, or at least excludes one or more capabilities. For example, the base station implemented as a gNB can refrain from transmitting UTRA capabilities to another gNB. As another example, the base station implemented as an eNB can refrain from transmitting UTRA capabilities to a gNB. In some implementations, the base station transmits the first RAT capabilities to a third base station or a core network at block 910. In other implementations, the base station does not transmit the first RAT capabilities to the third base station or the core network at block 910.

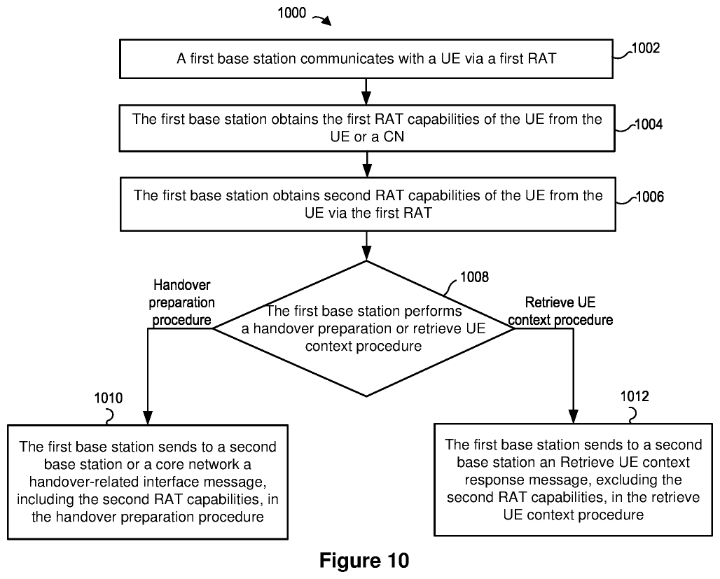

Now referring to FIG. 10, according to the method 1000, the base station determines that it should execute block 1010 and report the second RAT capabilities to another base station or the core network when the procedure being performed is a handover preparation procedure, or execute block 1012 and exclude second RAT capabilities from a message to a second bae station when the procedure being performed is a procedure for retrieving the UE context. The base station makes this determination at block 1008.

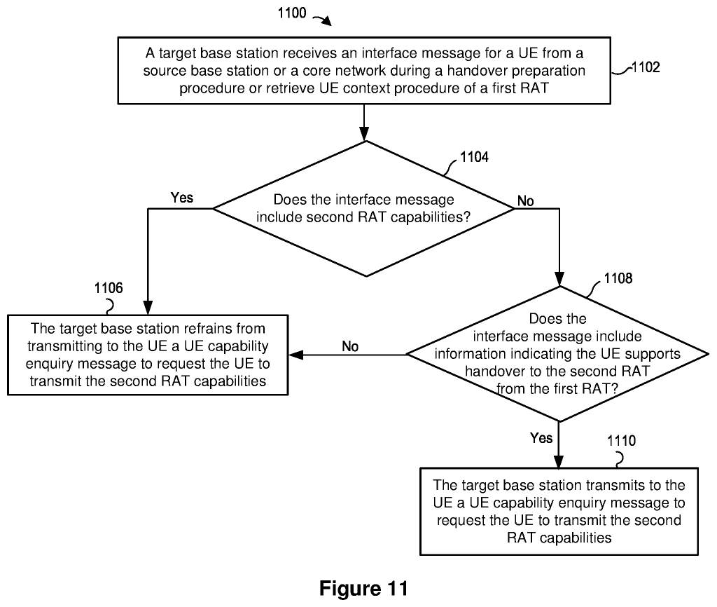

FIG. 11 is a flow diagram of an example method 1100 for determining whether a target base station should query a UE to determine the capability of the UE with respect to another RAT. The method 1100 can be implemented in the eNB 106B or gNB 106A, for example. At block 1102, the base station receives an interface message for a UE from a source base station (e.g., the gNB 104) or a core network, during a handover preparation procedure or retrieve UE context procedure of a first RAT (e.g., NR). If the base station determines at block 1104 that the interface message includes second RAT capabilities (e.g., EUTRA), the flow proceeds to block 1106, where the target base station refrains from querying the UE regarding the second RAT capabilities. In this manner, the target base station reduces amount of time spent on ascertaining the capability of the UE.

Otherwise, the flow proceeds to block 1108, where the base station determines whether the interface message indicates that the UE supports handover to the second RAT. If so, the flow proceeds to block 1110, where the target base queries the UE for the second RAT capabilities.

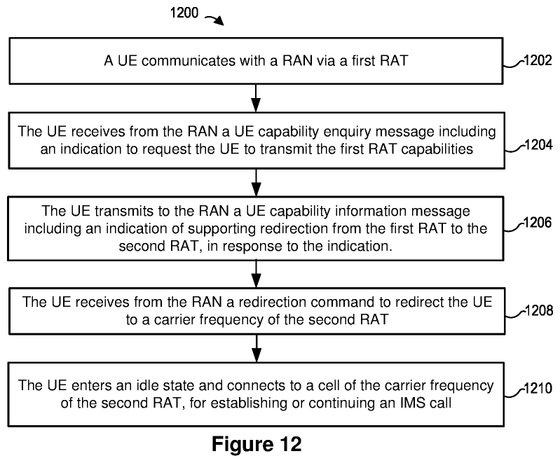

FIG. 12 is a flow diagram of an example method 1200 for providing RAT capability to a base station prior to redirection to another cell for establishing or continuing an IMS call, which can be implemented in the UE 102, for example. At block 1202, the UE communicates with the RAN via a first RAT (e.g., NR). At block 1204, the UE receives a capability enquiry message regarding the first RAT. In response, at block 1206, the UE transmits a UE capability information message that includes an indication that the UE supports redirection from the first RAT to the second RAT. In other words, the UE in this case reports a capability related to the second RAT without an explicit inquiry regarding the second-RAT capability from the RAN.

At block 1208, the UE receives a redirection command from the RAN, so as to redirect the UE to a carrier frequency of the second RAT. At block 1210, the UE enters the RRC_IDLE state and then connects to a cell of the carrier frequency of the second RAT. The UE can transition to the second RAT for initiating or continuing an IMS call without further delays.

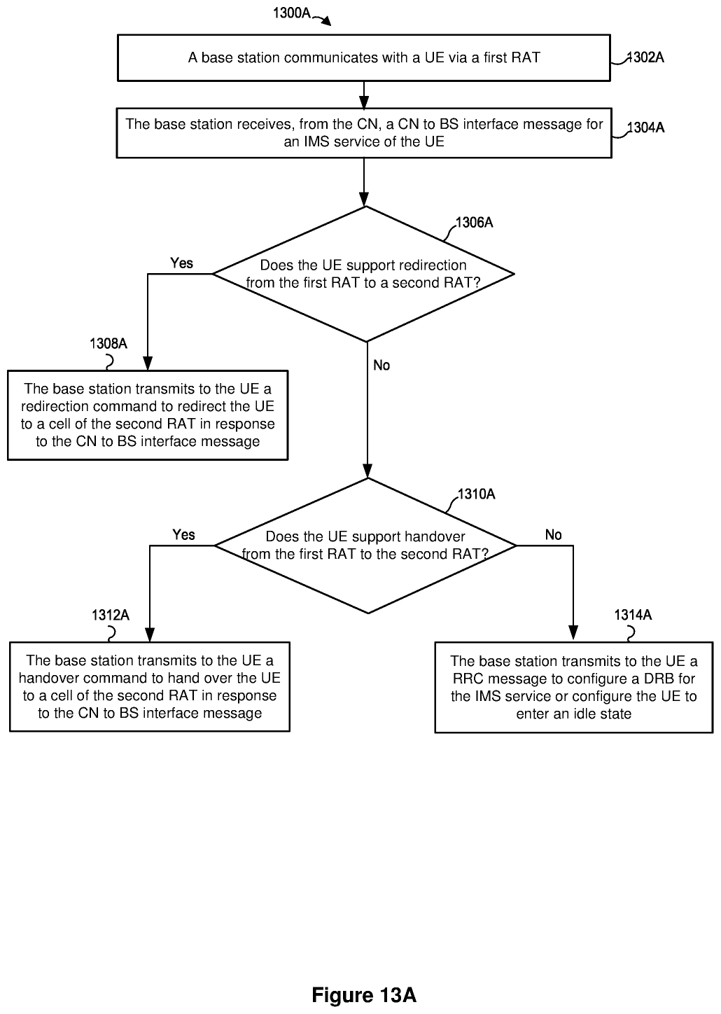

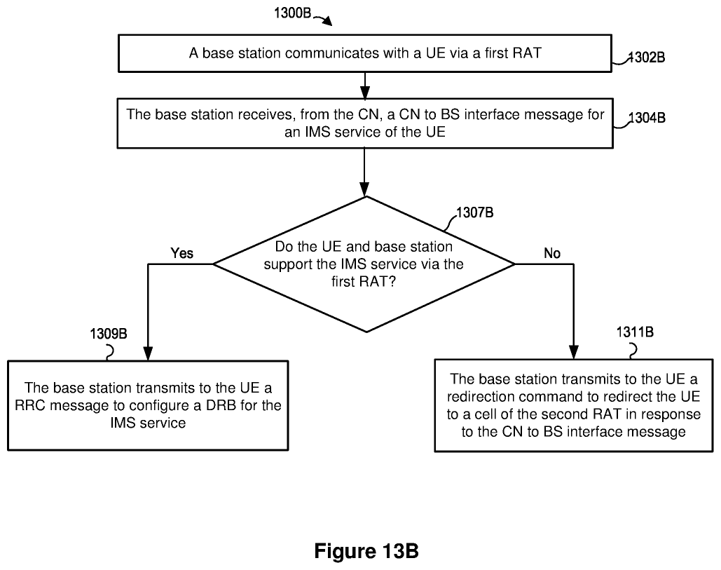

FIG. 13A is a flow diagram of an example method 1300A for determining how a base station should cause the UE to transition to another RAT for initiating or maintaining an IMS service, which can be implemented in the gNB 104, for example. At block 1302A the base station communicates with a UE via a first RAT (e.g., NR). At block 1304A, the base station receives a CN-to-BS interface message for an IMS service for the UE, from the CN.

If the base station determines at block 1306A that the UE supports redirection from the first RAT to the second RAT, the flow proceeds to block 1308A, where the base station transmits the corresponding redirection command to the UE. Otherwise, the flow proceeds to block 1310A, where the base station further determines whether the UE supports handover from the first to the second RAT. Depending on this determination, the base station either transmits a handover command to the UE at block 1312A or transmits an RRC message to the UE at block 1314A. The RRC message can configure a DRB for the IMS service or configure the UE to transition to RRC_IDLE.

FIG. 13B is a flow diagram of an example method 1300B for determining whether a base station should redirect a UE to another RAT for initiating or maintaining an IMS service, which can be implemented in the gNB 104. Blocks 1302B and 1304B are similar to blocks 1302A an 1304A, respectively. At block 1307B, the base station determines whether the UE and the base station support the IMS service via the first RAT (e.g., IMS voice over NR). The base station transmits an RRC message to configure a DRB for the IMS service at block 1309B if the UE and the base station support the IMS service over the RAT. Otherwise, at block 1311B, the base station transmits a redirection command to the UE, to redirect the UE to a cell of the second RAT.

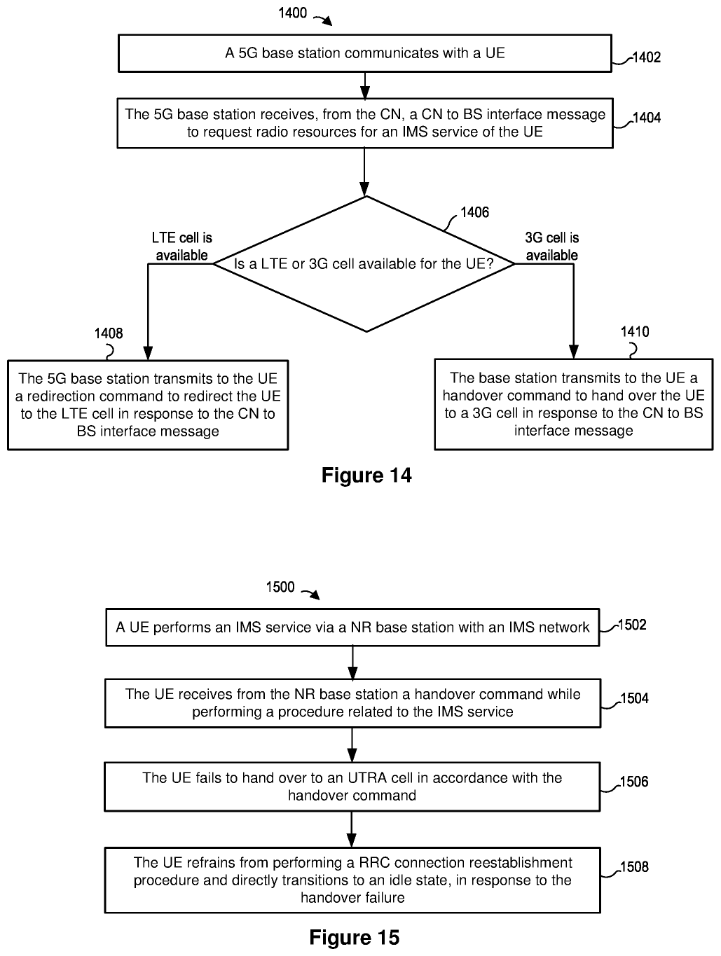

FIG. 14 is a flow diagram of another example method 1400 for determining whether a base station should redirect a UE to another RAT for initiating or maintaining an IMS service, based on cell availability, which can be implemented in the gNB 104 or another suitable 5G base station. At block 1402, the base station communicates with the UE over the 5G NR interface. Next, at block 1404, the base station receives a CN-to-BS interface message requesting radio resources for an IMS service, from the CN. If the base station determines at block 1406 that an LTE cell is available, the base station transmits a redirection command to redirect the UE to an LTE cell. If base station determines at block 1406 that a 3G cell is available, the base station transmits a handover command to hand the UE over to a 3G cell. The 5G base station and/or the UE in this scenario cannot establish a session of the requested IMS service over NR.

FIG. 15 is a flow diagram of an example method 1500 for processing handover failure while initiating an IMS service, which can be implemented in a UE 102 or another suitable UE. At block 1502, the UE performs an IMS service via an NR base station, via an IMS network. At block 1504, the UE receives a handover command from the NR base station, while performing a procedure related to the IMS service. At block 1506, the UE fails to hand over to an UTRA cell in accordance with the handover command. At block 1508, the UE determines to not perform an RRC connection establishment and instead directly transition to RRC_IDLE.

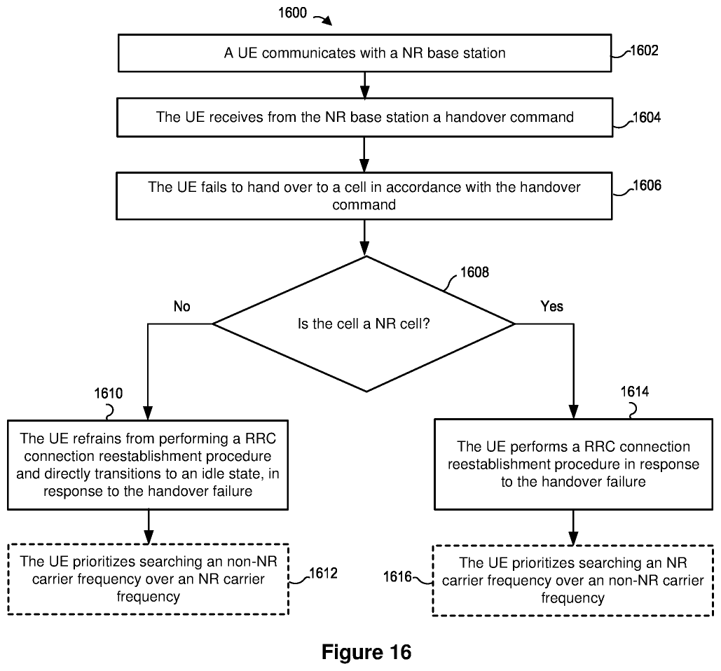

Now referring to FIG. 16, an example method 1600 for determining whether a UE should reestablish a radio connection with a RAN after a handover failure can be implemented in the UE 102 or another suitable UE. The UE initially communicates with an NR base station (block 1602). At block 1604, the UE receives a handover from the NR base station and, at block 1606, the UE fails to hand over to a target cell in accordance with the handover command. If the UE determines that the target cell is not an NR cell, the UE determines it should not perform an RRC connection reestablishment procedure and directly transitions to RRC_IDLE (block 1610). Optionally, the UE prioritizes non-NR carrier frequencies over NR carrier frequencies in the subsequent search for a new cell (block 1612). If the UE determines, at block 1608, that the target cell is an NR cell, the UE determines it should perform an RRC connection reestablishment procedure (block 1614). Optionally, the UE prioritizes NR carrier frequencies over non-NR carrier frequencies in the subsequent search for a new cell (block 1616).

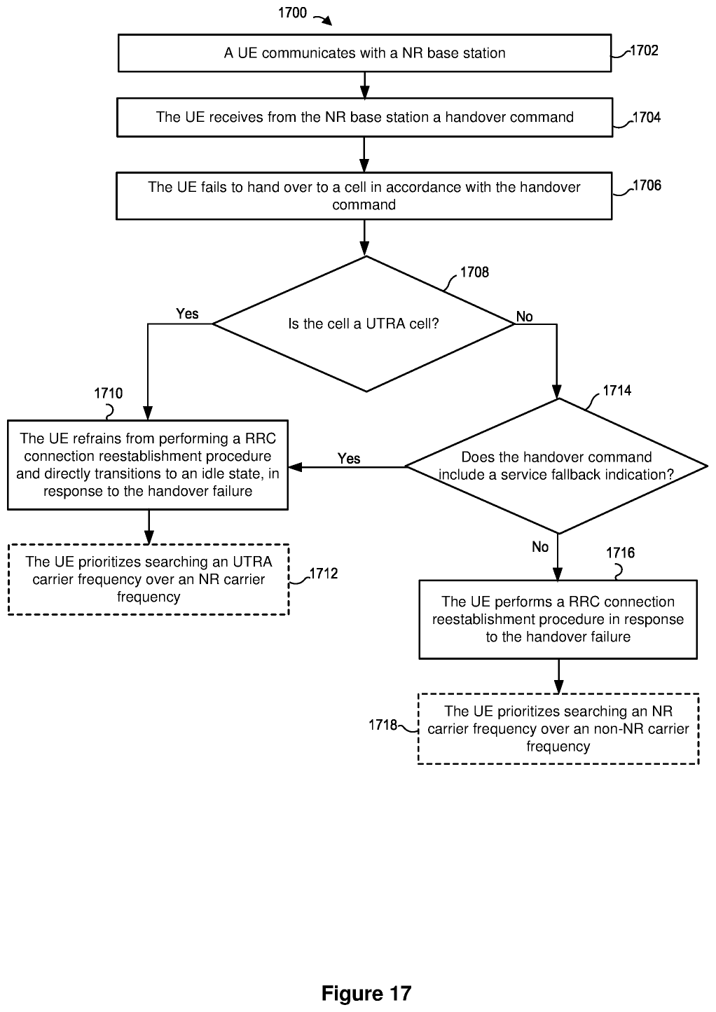

FIG. 17 is a flow diagram of another example method 1700 for determining whether a UE should reestablish a radio connection with a RAN after a handover failure, which also can be implemented in the UE 102 or another suitable UE. The method 1700 is similar to the method 1600, but here the UE determines whether the cell is an UTRA cell at block 1708. When the cell is an UTRA cell, the UE determines it should not perform an RRC connection reestablishment procedure and directly transitions to RRC_IDLE (block 1710). Optionally, the UE prioritizes UTRA frequencies over other carrier frequencies in the subsequent search for a new cell (block 1712). If the UE determines, at block 1708, that the target cell is an NR cell, the UE determines whether the handover command includes a service fallback indication (e.g., EPS fallback), at block 1714. The UE then determines it should perform an RRC connection reestablishment procedure (block 1716). Optionally, the UE prioritizes NR carrier frequencies over non-NR carrier frequencies in the subsequent search for a new cell (block 1718).

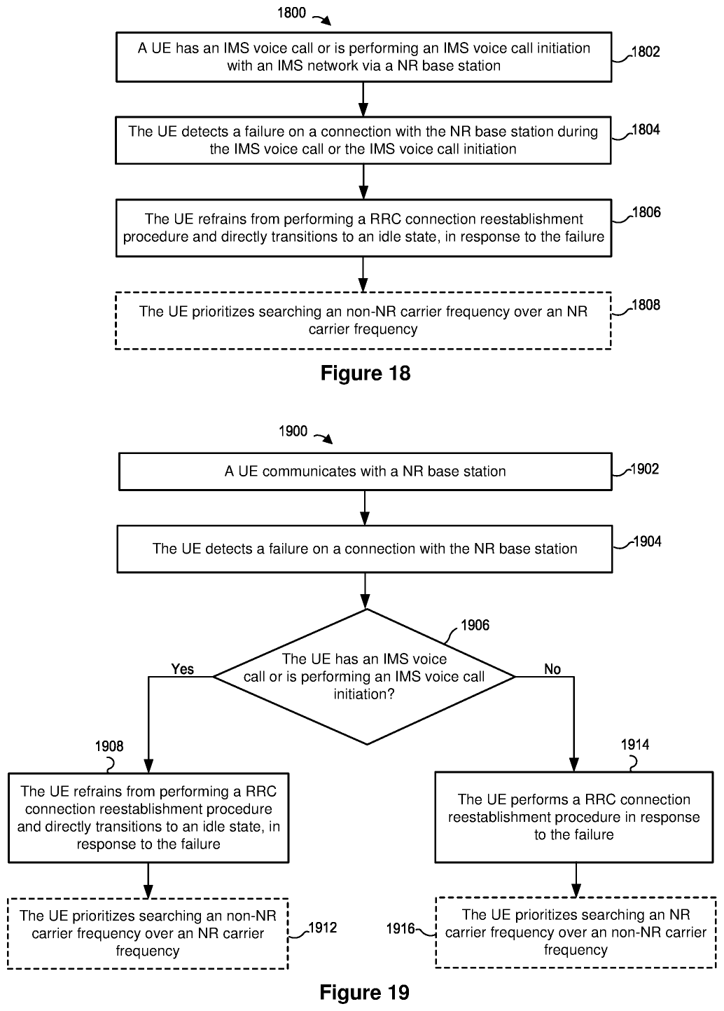

Referring to FIG. 18, an example method 1800 for determining whether a UE should reestablish a radio connection with a RAN after a handover failure and after the UE has initiated an IMS call can be implemented in the UE 102 or another suitable UE. At block 1802, the UE is in a session of an IMS voice call or is initiating a session, with an IMS network via an NR base station. The UE detects a failure of the radio connection during this procedure (block 1804) and, at block 1806, determines it should not perform an RRC connection reestablishment procedure and instead transition to RRC_IDLE. The UE optionally priorities searching for a non-NR carrier frequency at block 1808.

FIG. 19 is a flow diagram of an example method 1900 for determining whether a UE should reestablish a radio connection depending on whether the IMS has already been established, which can be implemented in the UE 102 or another suitable UE. The method 1900 is similar to the method 1600 discussed above, but at block 1906 the UE determines if the UE has already established an IMS voice call or is performing an initiation of an IMS voice call. The UE performs blocks 1908 (refraining from performing an RRC connection establishment procedure) and 1912 (prioritizing searching for non-NR carrier frequencies) when the voice call is established or is initiated. Otherwise, when the UE is not performing actions related to IMS services, the UE performs blocks 1914 (performing an RRC connection reestablishment) and 1916 (prioritizing searching for NR carrier frequencies).

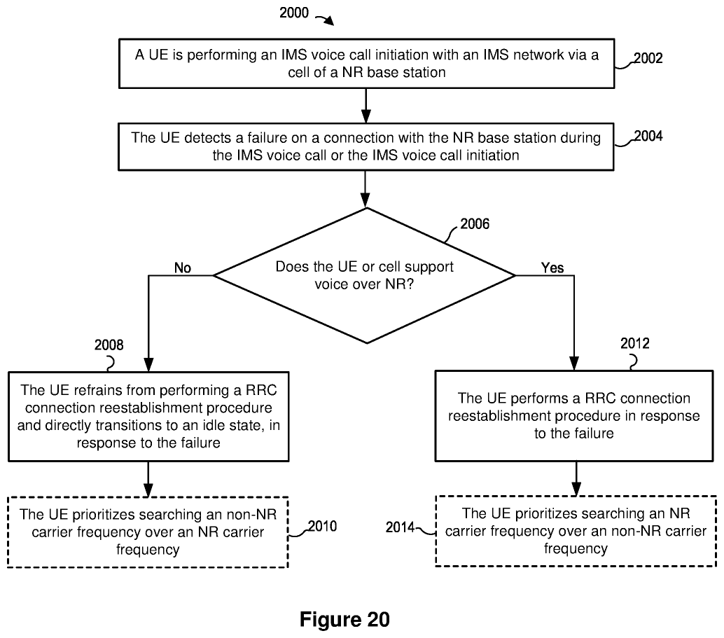

FIG. 20 is a flow diagram of an example method 2000 for determining whether a UE should reestablish a radio connection depending on whether the UE supports the service over a certain RAT, which can be implemented in the UE 102 or another suitable UE. The method 2000 is similar to the method 1600 discussed above, but at block 2006 the UE determines whether the UE or the cell support voice over NR. The UE performs blocks 2008 (refraining from performing an RRC connection establishment procedure) and 2010 (prioritizing searching for non-NR carrier frequencies) when the UE does not support voice over NR. Otherwise, when the UE supports voice over NR, the UE performs blocks 2012 (performing an RRC connection reestablishment) and 2014 (prioritizing searching for NR carrier frequencies).

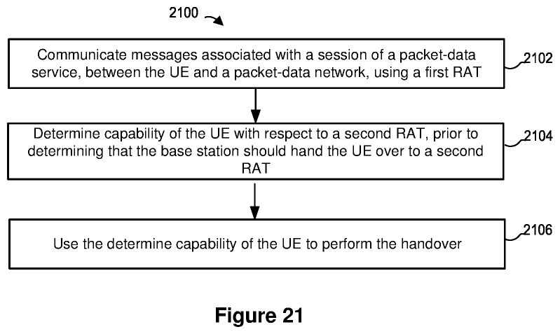

FIG. 21 is a flow diagram of an example method for providing continuity to a session of a packet-data service, which can be implemented in the gNB 104, for example. At block 2102, the base station communicates messages associated with a session of a packet-data service, between the UE and a packet-data network, using a first RAT (events 401, 402, 501, 602). At block 2104, the base station determines capability of the UE with respect to a second RAT, prior to determining that the base station should hand the UE over to a second RAT (events 408/410, 512, 616). At block 2106, the base station uses the determined capability of the UE to perform the handover (events 406/412, 590, 690).

The following additional considerations apply to the foregoing discussion.

In some implementations, “message” is used and can be replaced by “information element (IE)”. In some implementations, “IE” is used and can be replaced by “field”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects another additional embodiment explicitly contemplated by the present disclosure.

Example 1. A method in a user equipment (UE) for processing handover failure comprises: communicating, by processing hardware, messages associated with a session between the UE and a packet-data network, via a first base station and using a first RAT; receiving, by the processing hardware, a command instructing the UE to perform a handover to a second base station that supports a second RAT; in response to detecting a failure to complete the handover: refraining from performing a procedure for reestablishing a connection to the RAN, and transitioning to an idle state of a protocol for controlling radio resources.

Example 2. The method of example 2, further comprising: prioritizing, by the processing hardware, a search for cells associated with the second RAT over a search for cells associated with the first RAT.

Example 3. The method of example 1 or 2, wherein the first RAT is less advanced that the second RAT.

Example 4. The method of example 1, wherein the refraining is in response to determining that the UE has an established session of a packet-data service.

Example 5. The method of example 1, wherein the refraining is in response to determining that the UE has initiated but not established a session of a packet-data service.

Example 6. A method can be implemented in a first base station to provide continuity to a session of a packet-data service. The method includes communicating, by processing hardware, messages associated with the session between a UE and a packet-data network, using a first RAT; prior to determining that the UE should perform a handover to a second base station that supports a second RAT, determining, by the processing hardware, a capability of the UE with respect to the second RAT; and using, by the processing hardware, the determined capability of the UE to perform the handover.

Example 7. The method of example 6, wherein determining the capability of the UE includes receiving, by the processing hardware, an indication of the capability from the UE via the first RAT.

Example 8. The method of example 7, wherein determining the capability of the UE is in response to determining that the base station is located within a cell of the second base station.

Example 9. The method of example 7, wherein determining the capability of the UE is in response to receiving, from a packet-data network, a request to establish a session of a packet-data service between the UE and the packet-data network.

Example 10. The method of example 7, wherein determining the capability of the UE is in response to receiving, from the UE, a request to establish a session of a packet-data service between the UE and a packet-data network.

Example 11. The method of any of examples 7-10, wherein communicating the messages associated with the session includes communicating the messages of an established call, prior to determining the capability of the UE.

Example 12. The method of any of examples 7-10, wherein communicating the messages associated with the session includes communicating the messages for establishing a new call, prior to determining the capability of the UE.

Example 13. The method of any of examples 7-12, wherein receiving the indication of capability includes: transmitting, by the processing hardware to the UE, a UE capability enquiry message specifying the second RAT; and receiving, by the processing hardware from the UE, a UE capability response message that includes the indication of the capability.

Example 14. The method of any of examples 7-12, wherein receiving the indication of capability includes: transmitting, by the processing hardware to the UE, a UE capability enquiry message specifying only the first RAT; and receiving, by the processing hardware from the UE, a UE capability response message that includes the indication of the capability.

Example 15. The method of any examples 7-14, further comprising, subsequently to determining the capability: in response to determining that the first station has initiated a preparation procedure for the handover, transmitting the indication of the capability to (i) the second base station or (ii) a core network to which the first base station and the second base station are connected.

Example 16. The method of any of examples 7-15, further comprising, subsequently to determining the capability: in response to determining that the first station has initiated a preparation procedure for the handover, transmitting the indication of the capability to the second base station.

Example 17. The method of example 16, further comprising, subsequently to determining the capability: in a second instance, in response to determining that the first station is performing a procedure for retrieving a context of the UE, refraining from providing the capability to the second base station in a response to a request for the context.

Example 18. The method of example 6, wherein determining the capability of the UE includes: receiving an indication of the capability from another base station.

Example 19. The method of example 18, wherein receiving the indication includes: receiving a handover request from the other base station, the handover request message including the indication.

Example 20. The method of example 18, wherein receiving the indication includes: receiving, by the processing hardware, a request to resume a suspended radio connection between the UE and a second base station; and in response to the request, retrieving a context for the UE from the second base station, the context including the indication.

Example 21. The method of any of examples 18-20, wherein communicating the messages associated with the session includes communicating the messages of a call previously established over another base station, subsequently to determining the capability of the UE.

Example 22. The method of any of examples 18-20, wherein communicating the messages associated with the session includes communicating the messages for establishing a new call, subsequently to determining the capability of the UE.

Example 23. A base station comprising processing hardware and configured to implement a method according to any of examples 7-22.

Example 24. A method in a user equipment (UE) for using a packet-data service, the method comprising: communicating, by processing hardware, via a first base station using a first RAT; receiving, by the processing hardware from the first base station, a query related to a capability of the UE with respect to only the first RAT; transmitting, by the processing hardware to the first base station, a response to the query, the response including an indication of a capability of the UE with respect to redirection from the first RAT to a second RAT; in response to receiving a message from the first base station, connecting to a second base station using a second RAT; andsommunicating, by the processing hardware via the second base station, messages associated with a session between the UE and a packet-data network.

Example 25. The method of example 24, wherein receiving the message includes receiving a command to release a radio connection with the first base station.

Example 26. The method of example 24, wherein receiving the message includes receiving a handover command instructing the UE to transition to the second base station.

Example 27. The method of example 24, wherein the indication of the capability of the UE includes an evolved packet system (EPS) fallback indication.

Example 28. The method of any of examples 24-27, wherein communicating via the first base station using the first RAT includes communicating messages for establishing a call.

Example 29. The method of any of examples 24-27, wherein communicating via the first base station using the first RAT includes communicating messages of an established call.

Example 30. A UE comprising processing hardware and configured to implement a method according to any examples 24-29.

1. A method in a first base station for providing Single Radio Voice Call Continuity (SRVCC) to a session of a packet-data service, the method comprising:
communicating messages associated with the session between a UE and a packet-data network, using NR or EUTRA;
determining a capability of the UE with respect to UTRA; and
transmitting, to a second base station, handover preparation information for the UE, including causing the second base station to not apply the capability of the UE with respect to UTRA.

2. The method of claim 1, wherein causing the second base station to not apply the capability includes:
omitting an indication of the capability from an interface message that includes the handover preparation information.

3. The method of claim 1, wherein determining the capability includes:
determining the capability prior to determining that the UE should perform a handover to the second base station.

4. The method of claim 1, wherein the transmitting includes:
transmitting HandoverPreparationInformation during handover preparation.

5. The method of claim 1, wherein the transmitting includes:
transmitting HandoverPreparationInformation during UE context retrieval.

6. The method of claim 1, wherein the second base station is a gNB.

7. The method of claim 1, wherein determining the capability is in response to one of:
(i) determining that the base station is located within a cell of the second base station,
(ii) receiving, from a packet-data network, a request to establish a session of a packet-data service between the UE and the packet-data network,
(iii) receiving, from the UE, a request to establish a session of a packet-data service between the UE and a packet-data network.

8. The method of claim 1, wherein determining the capability includes:
transmitting, by the processing hardware to the UE, a UE capability enquiry message specifying the second RAT; and
receiving, by the processing hardware from the UE, a UE capability response message that includes the indication of the capability.

9. The method of claim 1, wherein determining the capability includes:
transmitting, by the processing hardware to the UE, a UE capability enquiry message specifying only the first RAT; and
receiving, by the processing hardware from the UE, a UE capability response message that includes the indication of the capability.

10. The method of claim 1, wherein determining the capability includes:
receiving an indication of the capability from another base station.

11. The method of claim 10, wherein receiving the indication includes:
receiving a handover request from the other base station, the handover request message including the indication.

12. The method of claim 10, wherein receiving the indication includes:
receiving a request to resume a suspended radio connection between the UE and a second base station; and
in response to the request, retrieving a context for the UE from the second base station, the context including the indication.

13. The method of claim 1, wherein communicating the messages associated with the session includes:
communicating the messages of a call previously established over another base station, subsequently to determining the capability of the UE.

14. The method of claim 1, wherein communicating the messages associated with the session includes:
communicating the messages for establishing a new call, subsequently to determining the capability of the UE.

15. A base station comprising processing hardware and configured to:
communicate messages associated with the session between a UE and a packet-data network, using NR or EUTRA;
determine a capability of the UE with respect to UTRA; and
transmit, to a second base station, handover preparation information for the UE, including causing the second base station to not apply the capability of the UE with respect to UTRA.

16. A method in a target base station for providing Single Radio Voice Call Continuity (SRVCC) to a session of a packet-data service, the method comprising:
receiving, from a source base station associated with the session and a first radio access technology (RAT), an interface message including an indication of a capability of a user equipment (UE) with respect to a second RAT, in connection with a procedure related to a handover or UE context retrieval; and
in response to the indication, refraining from transmitting, to the UE, a message related to the second RAT.

17. The method of claim 16, wherein the indication of the capability of the UE with respect to the second RAT is included in a HandoverPreparationInformation message.

18. The method of claim 16, wherein the second RAT is UMTS Terrestrial Radio Access (UTRA).

19. The method of claim 16 implemented in a gNB.

20. The method of claim 16, wherein the message related to the second RAT includes a UE capability enquiry.
